(19) United States
(12) Patent Application Publication
(10) Pub. No.: US 2021/0084399 A1
(43) Pub. Date: Mar. 18, 2021

(54) HEARING DEVICE USING BONE CONDUCTION

(71) Applicant: BOCO INC., Tokyo (JP)

(72) Inventor: Hataaki Sha, Tokyo (JP)

(21) Appl. No.: 16/971,026

(22) PCT Filed: Feb. 22, 2018
(86) PCT No.: PCT/JP2018/006406

§ 371 Date: Aug. 19, 2020

(51) Int. Cl. H04R 1/10

(52) U.S. Cl. CPC H04R 1/1008; H04R 2460/13; H04R 1/1075; H04R 1/105

(57) ABSTRACT

The purpose of the present invention is to provide a hearing device using bone conduction which can be easily worn according to the physical features of respective wearers. The hearing device comprises a bone conduction speaker in which a bone conduction drive is included, and an ear hook part. The hearing device is characterized in that the relative position between the bone conduction speaker and the ear hook part can be changed.

### TECHNICAL FIELD OF THE INVENTION

The present invention relates to a hearing device employing bone conduction that enables a hearer to perceive sound by conducting vibrations to bones, and more particularly to a hearing device that can be easily worn according to the physical features of respective wearers.

### BACKGROUND OF THE INVENTION

As a means of listening to music or sounds of radio and television, or a means for conversations over mobile phones or wireless devices, devices such as headphones and earphones worn over or in ears for listening sounds and music (hereinafter, hearing devices) have been widely used conventionally. For example, headphones, which are commonly used hearing devices, are worn by being plugged into earholes or by covering entire ears. Such headphones use a mechanism in which a sound source that is input as electric signals is converted into air vibrations that are then transmitted to and vibrate an eardrum, and the vibrations of the eardrum travel inside the ear through a middle ear so that information of the sound is transmitted to and perceived by a brain.

However, instead of the mechanism in which air vibrations vibrate a user's eardrum as above, hearing devices employing bone conduction in which sound vibrations are conducted to the user's skull so that sounds can be recognized by vibrations of bones have been developed in recent years. Unlike headphones and earphones, the user does not have to insert such a bone conduction hearing device into his/her earhole. Thus, it is safer for the user since he/she can hear unblocked surrounding sound while wearing the device. Also, since bone conduction does not use eardrum vibrations, even people with hearing difficulties would be able to perceive sounds through bone conduction. Thus, hearing aids and the like employing bone conduction have been advanced.

Such a hearing device employing bone conduction converts acoustic signals that are input as electric signals into mechanical vibrations and conducts the vibrations from an appropriate position to bones so that the hearer can perceive the sound as bone-conducted sound through vibrations. Examples of the appropriate position are parts like areas around temples, or mastoid process which is a large protrusion at the lower back part of the temporal bone.

The area around temples in other words is the skull itself. If a vibrating part comes into contact with the temples area properly, sound vibrations can be transmitted to the bones accurately. Thus, hearing devices employing bone conduction, especially headphone types, widely adopt such temple-contacting method.

In addition, it is important for such type of hearing device employing bone conduction to make sure that the vibrating part is in contact with the temples area with accuracy. Thus, such hearing device is in an arm shape so that the device can be used being hanged over an upper part of the ear.

On the other hand, as a device that conducts vibrations to the mastoid process instead of the temples area, Japanese Unexamined Patent Application Publication No. 1990-62199 (JP-A-1990-62199) titled “Bone conduction type sound hearing device and a method for the same” discloses a structure in which a speaker as a bone conduction means is disposed inside a substantially C-shaped housing so as to cover most of the mastoid process of a hearer.

The above structures that conduct vibrations either to the temples area or the mastoid process can be worn without blocking the ears, and thus, as mentioned above, it is safer for the user since he/she can hear unblocked surrounding sound while wearing the device and people with hearing difficulties would be able to perceive sounds.

As mentioned above, a hearing device employing bone conduction enables hearing of sounds by contacting its vibrating part at an appropriate position. To transmit vibrations from the vibrating part that is in contact with the appropriate position to the bones, it is necessary to apply a certain amount of contacting pressure, and thus tightening is required. This is because, if the tightening is weak and the vibrating part is merely touching the bones, the vibrations will not transmit properly and a user will find it difficult to perceive sounds.

However, for the hearing device employing bone conduction with the vibrating part to be in contact with the temples area as above, tightening around the temples area may cause strong stress, which can cause pain, and, in addition, depending on a shape of an ear of a wearer, an arm-shaped ear hook part that is hanged on an upper part of the ear may not fit to the ear and may cause pain. Also, if the vibrating part is shifted from the appropriate position due to unstable fitting, adjustment is needed to set the vibration part back to the appropriate position again so it is not suitable to be used during exercises.

Also, although the structure in which a vibrating part is disposed so as to cover most of the mastoid process as in Patent Document 1 does not tighten as strong as the one covering the temples area, the substantially C-shaped housing is large and has some weight with poor design, which draw attention, and it is also required to adjust the C-shaped form according to the size of the ear since it is structured to be worn at the back of the ear between the ear and the head.

Furthermore, since a position of the mastoid process varies from person to person, adjustment for disposing and contacting position of the vibration part of the hearing device is necessary. Thus, it is required to manufacture and prepare various types of devices with different sizes to fit physical features of the wearers, and this sometimes requires full customer-made production for particular use. This problem inhibits the spread of sound recognition devices employing bone conduction.

### SUMMARY OF THE INVENTION

To solve the problems of the above-mentioned prior art, the present invention provides a hearing device employing bone conduction that can be easily worn according to the physical features of respective wearers.

To achieve the above object, the inventor of the present application has invented following devices after earnest research:

A hearing device employing bone conduction including a bone conduction speaker accommodating a bone conduction drive, and an ear hook part, in which a relative position between the bone conduction speaker and the ear hook part can be changed;

The hearing device employing bone conduction according to (1) above, in which the relative position between the bone conduction speaker and the ear hook part can be changed by an extensible mechanism of an ear-hook-arm supporter that forms the ear hook part;

The hearing device employing bone conduction according to (1) above, in which a tube-shaped ear-hook arm is provided at a part of a circumference of the ear hook part, and the relative position between the bone conduction speaker and the ear hook part can be changed by a mechanism that allows the bone conduction speaker to move between one end and the other end of the ear-hook arm using the ear-hook arm as a guide.

The present invention is not limited to the embodiments described above or to embodiments described in detailed descriptions below. Needless to say, various examples of changes or modifications within the scope of the technical idea of the present invention are possible.

According to the present invention,

(1) the hearing device employing bone conduction includes a bone conduction speaker accommodating a bone conduction drive, and an ear hook part, in which a relative position between the bone conduction speaker and the ear hook part can be changed. Thus, the positions of the ear hook part and the bone conduction speaker can be adjusted depending on physical features of respective wearers so the wearer does not receive stress due to tightening. Moreover, the hearing device is small-sized and lightweight with good design, easy to wear or remove, and comfortable to wear.

Also, the hearing device employs bone conduction and does not block earholes, and therefore has high safety. Thus, the hearing device can be used for devices in various fields, such as in headphone mikes, hearing aids, and helmets that enable conversations in noisy locations.

(2) Also, since the relative position between the bone conduction speaker and the ear hook part can be changed by an extensible mechanism of the ear-hook-arm supporter, in addition to the above-mentioned effects, the wearer can easily adjust the positions of the ear hook part and the bone conduction speaker when wearing the device.

(3) Furthermore, the tube-shaped ear-hook arm is provided at a part of a circumference of the ear hook part, and the relative position between the bone conduction speaker and the ear hook part can be changed by the mechanism that allows the bone conduction speaker to move between one end and the other end of the ear-hook arm using the ear-hook arm as a guide. Thus, the wearer can easily dispose the bone conduction speaker at an appropriate position by only moving and adjusting the position of the bone conduction speaker when wearing the device.

### BRIEF DESCRIPTION OF DRAWINGS

FIG. 1a is a view illustrating a Working Example 1 of a hearing device according to the present invention.

FIG. 1b is a view illustrating a Working Example 1 of a hearing device according to the present invention.

FIG. 2 is a view illustrating a state of wearing the Working Example 1 of the hearing device according to the present invention.

FIG. 3 is an enlarged view illustrating the state of wearing the Working Example 1 of the hearing device according to the present invention.

FIG. 4a is a view illustrating another working example of the Working Example 1 of the hearing device according to the present invention.

FIG. 4b is a view illustrating another working example of the Working Example 1 of the hearing device according to the present invention.

FIG. 4c is a view illustrating another working example of the Working Example 1 of the hearing device according to the present invention.

FIG. 5a is a view illustrating an external appearance of a Working Example 2 of the hearing device according to the present invention.

FIG. 5b is a view illustrating an external appearance of a Working Example 2 of the hearing device according to the present invention.

FIG. 6a is a view illustrating the Working Example 2 of the hearing device according to the present invention.

FIG. 6b is a view illustrating the Working Example 2 of the hearing device according to the present invention.

FIG. 6c is a view illustrating the Working Example 2 of the hearing device according to the present invention.

FIG. 7a is a view illustrating an external appearance of another working example of the Working Example 2 of the hearing device according to the present invention.

FIG. 7b is a view illustrating an external appearance of another working example of the Working Example 2 of the hearing device according to the present invention.

### DESCRIPTION OF SOME EMBODIMENTS

Hereinafter, some embodiments of a hearing device employing bone conduction according to the present invention will be described in detail with reference to the accompanying drawings of working examples.

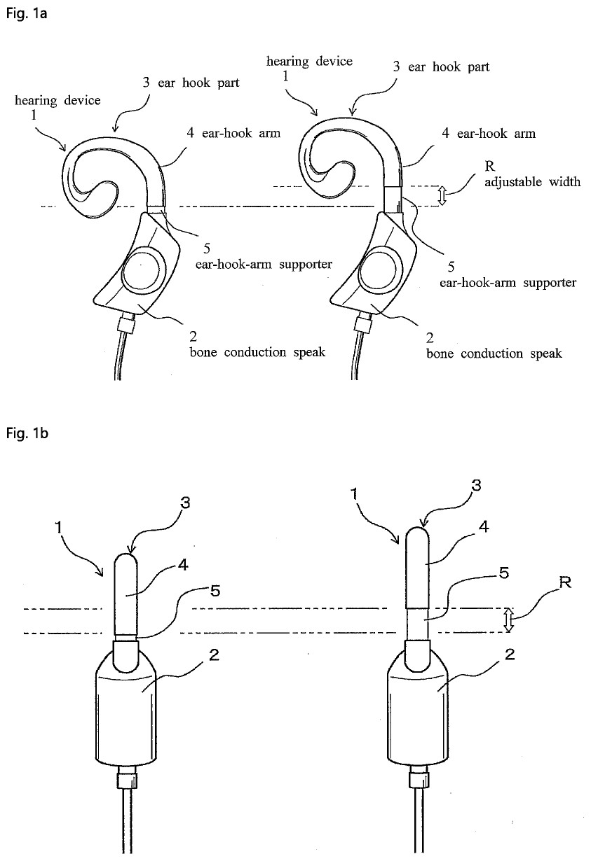

Views in FIG. 1 illustrate a Working Example 1 of a hearing device according to the present invention, where FIG. 1a shows front views and FIG. 1b show side views. The drawings in FIG. 1 show a hearing device 1, a bone conduction speaker 2, an ear hook part 3, an ear-hook arm 4, an ear-hook-arm supporter 5, and an adjustable width R.

### Working Example 1

In the Working Example 1 of the hearing device according to the present invention shown in FIG. 1, the hearing device 1 includes the bone conduction speaker 2 accommodating a bone conduction drive, and the ear hook part 3.

The ear hook part 3 includes the ear-hook arm 4 and the ear-hook-arm supporter 5, and the ear-hook-arm supporter 5 joins the ear-hook arm 4 to the bone conduction speaker 2.

In the present Working Example 1, the ear-hook arm 4 is configured so that the ear-hook arm 4 can move in a longitudinal direction of the ear-hook-arm supporter 5 by means of an extensible mechanism.

This structure enables to change a relative position between the ear-hook arm 4 and the bone conduction speaker 2.

The extensible mechanism is not limited in particular and any publicly known extensible structure may be applied. For example, the ear-hook arm 4 is joined at spots with the ear-hook-arm supporter 5 by providing a long and thin groove part along the longitudinal direction of the ear-hook-arm supporter 5, or an extensible structure using spring or rubber material may also be applied.

FIG. 1a (left) shows a front view and FIG. 1b (left) shows a side view of the Working Example 1 of the hearing device 1 according to the present invention. In this state, a length of the ear-hook-arm supporter 5 that supports the ear-hook arm 4 is the shortest by the extensible mechanism, and the relative position between the bone conduction speaker 2 and the ear-hook part 3 is the closest.

On the other hand, in the state shown in a front view in FIG. 1a (right) and a side view in FIG. 1b (right), the length of the ear-hook-arm supporter 5 that supports the ear-hook arm 4 is the longest by the extensible mechanism, and the relative position between the bone conduction speaker 2 and the ear-hook part 3 is the farthest.

In the present working example, the length that can be adjusted by the extensible mechanism is a width shown by an arrow R. This width may be longer so as to be adjusted to suit physical features of wearers. The present working example is configured so that the width can be adjusted to any length between 0 and 30 mm approximately.

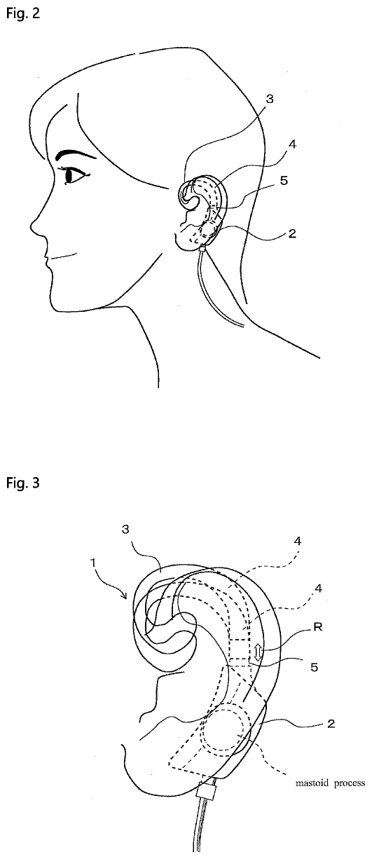

FIG. 2 is a view illustrating a state of wearing the Working Example 1 of the hearing device according to the present invention, and FIG. 3 is an enlarged view illustrating the state of wearing the Working Example 1 of the hearing device according to the present invention.

As shown in the drawings, the hearing device according to the Working Example 1 is worn by disposing the bone conduction speaker 2 around the mastoid process area.

Thus, if the bone conduction speaker 2 is above the mastoid process area when wearing the device, the extensible mechanism is extended so as to increase and adjust a distance between the ear hook part 3 and the bone conduction speaker 2.

On the other hand, if the bone conduction speaker 2 is below the mastoid process area, the extensible mechanism is contracted so as to decrease and adjust the distance between the ear hook part 3 and the bone conduction speaker 2.

As above, the hearing device 1 of the Working Example 1 has a structure in which the bone conduction speaker 2 is disposed around the mastoid process area having high hearing sensibility first, and then the position of the ear hook part 3 is adjusted accordingly.

The bone conduction speaker 2 according to the present invention accommodates the bone conduction drive that convers acoustic signals into vibrations. Converting acoustic signals into vibrations means to convert acoustic electrical signals that are input from the outside into mechanical vibrations. The bone conduction drive vibrates a diaphragm or the like by the acoustic electric signals and converts the acoustic electric signals into mechanical vibrations that are then transmitted to bones. In the present invention, a type of vibrating system of the bone conduction drive accommodated inside the bone conduction speaker 2 is not particularly limited as long as the acoustic electric signals can be converted into mechanical vibrations, and any types of conventional methods such as piezoelectric, electromagnetic, or super-magnetostrictive methods are applicable.

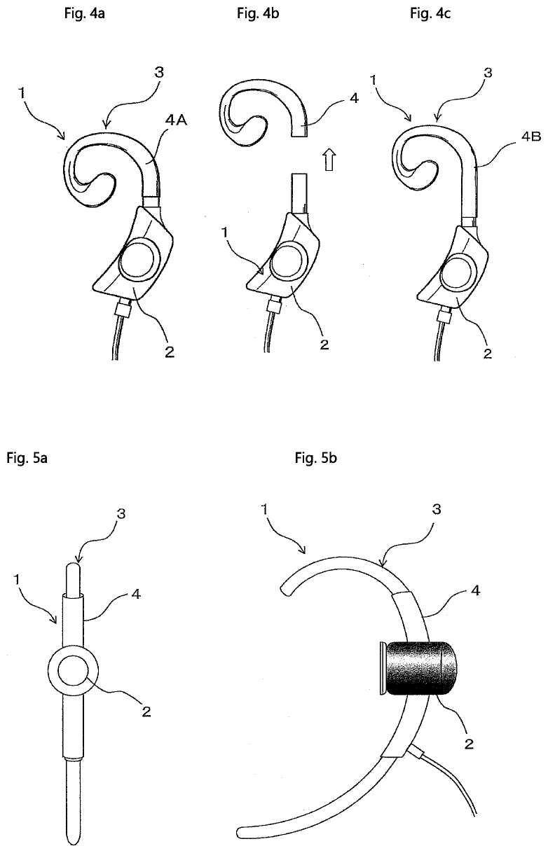

FIG. 4 shows another working example of the Working Example 1 of the hearing device according to the present invention.

In this working example, the ear-hook arm 4 has a structure that is detachable from the ear-hook-arm supporter 5. In such a structure, if the bone conduction speaker 2 is at a higher position than the mastoid process area at the time of wearing the hearing device 1, a short ear-hook arm 4a is inserted into the ear-hook-arm supporter 5; or if the bone conduction speaker 2 is at a lower position than the mastoid process area, a long ear-hook arm 4b is inserted into the ear-hook-arm supporter 5; so as to adjust the relative position between the bone conduction speaker 2 and the ear hook part 3.

### Working Example 2

FIG. 5 is a view illustrating an external appearance of a Working Example 2 of the hearing device according to the present invention. The hearing device 1 according to the Working Example 2 includes the bone conduction speaker 2 and the ear hook part 3. Also, the tube-shaped ear-hook arm 4 is provided at a part of a circumference of the ear hook part 3.

The hearing device 1 according to the Working Example 2 is structured to have a mechanism that allows the bone conduction speaker 2 to move (slide) between one end and the other end of the ear-hook arm 4 using the ear-hook arm 4 as a guide.

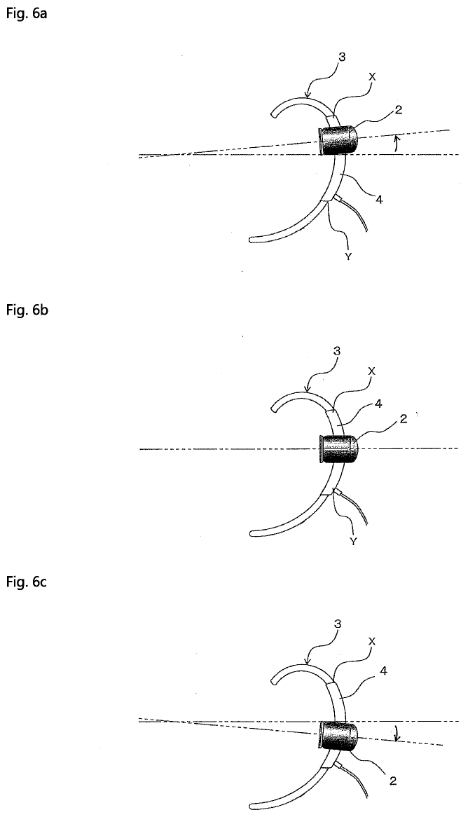

That is, the bone conduction speaker 2 moves, as shown in FIG. 6, from a center position shown in FIG. 6b either toward X, which is one end of the ear-hook arm 4, as shown in FIG. 6a, or toward Y, which is the other end of the ear-hook arm 4, as shown in FIG. 6c.

The bone conduction speaker 2 according to the present working example is structured to apply vibrations to the skull at the back of the ear, and the position where a wearer can hear sound clearly varies depending on a shape of the wearer's ear or the like.

Thus, when wearing the device, the bone conduction speaker 2 itself is moved and adjusted to the position where the sound can be clearly heard.

It is also preferable that the hearing device 1 of the Working Example 2 includes, for example, a locking member A or a locking member B for the ear at a part of the ear-hook arm 4 so that the hearing device 1 can be worn stably on the ear.

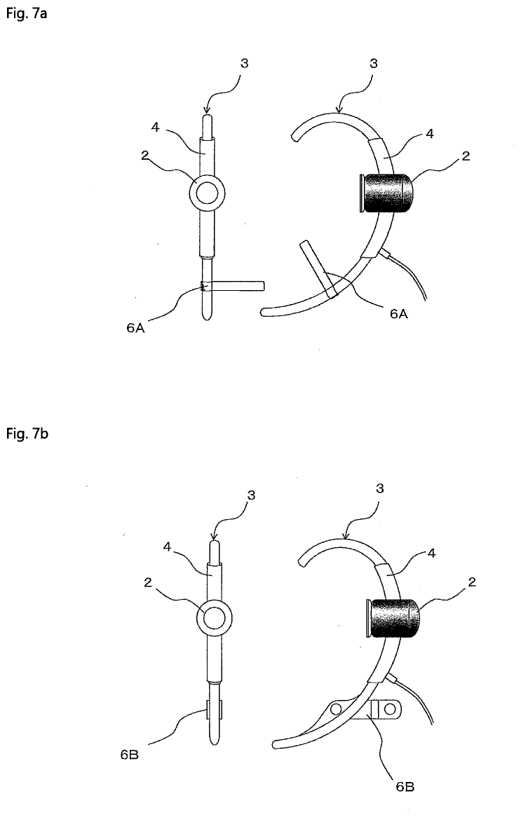

As the locking member, a clip-type locking member 6A as shown in FIG. 7a or a magnet-type locking member 6B as shown in FIG. 7b are light-weight and suitable.

Needless to say, the hearing device 1 according to the present invention can be used by fitting into one ear or to both ears.

When used by fitting into both ears, the hearing device 1 according to the present invention is attached to each end of a neckband or cord.

Also, the hearing device 1 according to the present invention can serve as a microphone by attaching a mike, or may be used as a hearing aid by attaching a sound collector, and can be used in various devices and equipment employing bone conduction.

### INDUSTRIAL APPLICABILITY OF THE INVENTION

The present invention relates to a hearing device employing bone conduction and is not limited to bone conduction headphones, and can be used in various devices and equipment employing bone conduction, such as hearing aids, microphones, and equipment for hearing conversations taking place in noisy places.

What is claimed is:

1. A hearing device employing bone conduction, comprising:
a bone conduction speaker accommodating a bone conduction drive; and
an ear hook part, wherein
a relative position between the bone conduction speaker and the ear hook part can be changed.

2. The hearing device employing bone conduction according to claim 1, wherein
the relative position between the bone conduction speaker and the ear hook part can be changed by an extensible mechanism of an ear-hook-arm supporter that forms the ear hook part.

3. The hearing device employing bone conduction according to claim 1, wherein
a tube-shaped ear-hook arm is provided at a part of a circumference of the ear hook part, and the relative position between the bone conduction speaker and the ear hook part can be changed by a mechanism that allows the bone conduction speaker to move between one end and the other end of the ear-hook arm using the ear-hook arm as a guide.
